(19) United States
(12) Patent Application Publication
(10) Pub. No.: US 2023/0413958 A1
(43) Pub. Date: Dec. 28, 2023

(54) BAND LINK, WATCH BAND, WATCH, AND MANUFACTURING METHOD OF BAND LINK

(71) Applicant: CASIO COMPUTER CO., LTD., Tokyo (JP)

(72) Inventor: Masao AMANO, Uenohara-shi (JP)

(73) Assignee: CASIO COMPUTER CO., LTD., Tokyo (JP)

(21) Appl. No.: 18/332,061

(22) Filed: Jun. 9, 2023

(30) Foreign Application Priority Data
Jun. 23, 2022 (JP) 2022-100987

(51) Int. Cl. A44C 5/02; B22F 5/00; B22F 3/15; B22F 10/64; B33Y 10/00; B33Y 40/20; B33Y 80/00

(52) U.S. Cl. CPC A44C 5/02; B22F 5/00; B22F 3/15; B22F 10/64; B33Y 10/00; B33Y 40/20; B33Y 80/00; B22F 2998/10; B22F 2301/205; B22F 2301/15

(57) ABSTRACT

A band link according to an embodiment of the present disclosure includes: a base layer formed of a first metallic material and the base layer being with a hole portion in which a coupling member is disposed; and a cover layer formed of a second metallic material that is different from the first metallic material, the cover layer being stacked on one side of the base layer, the base layer and the cover layer being formed as one piece.

### CROSS-REFERENCE TO RELATED APPLICATIONS

This application is based upon and claims the benefit of priority from Japanese Patent Application No. 2022-100987, filed Jun. 23, 2022, the entire contents of which are incorporated herein by reference.

### FIELD

The present invention relates generally to a band link, a watch band, a watch, and a manufacturing method of a band link.

### SUMMARY

To solve the problem, a band link according to an embodiment comprises; a base layer formed of a first metallic material and the base layer being with a hole portion in which a coupling member is disposed; and a cover layer formed of a second metallic material that is different from the first metallic material, the cover layer being stacked on one side of the base layer, the base layer and the cover layer being formed as one piece.

### BRIEF DESCRIPTION OF THE DRAWINGS

FIG. 1 is a plan view illustrating a configuration of a watch according to a first embodiment.

FIG. 2 is an explanatory view illustrating a configuration of a part of a band of the watch.

FIG. 3 is a cross-sectional view of a band link of the band of the watch.

FIG. 4 is an explanatory view illustrating a manufacturing method of the band of the watch.

### DETAILED DESCRIPTION

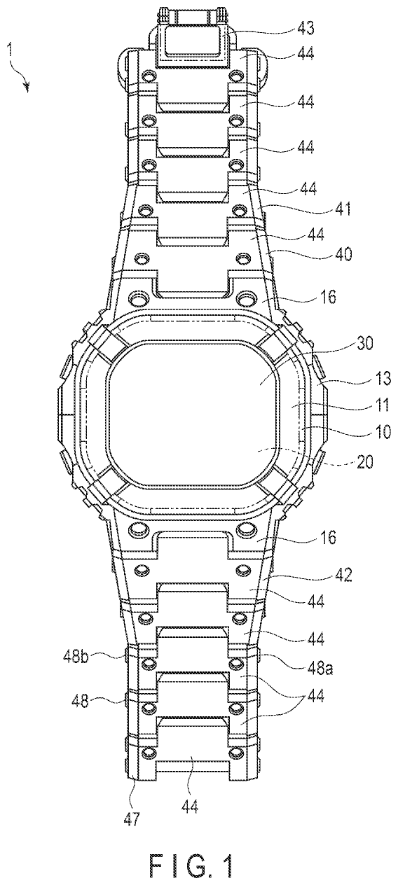

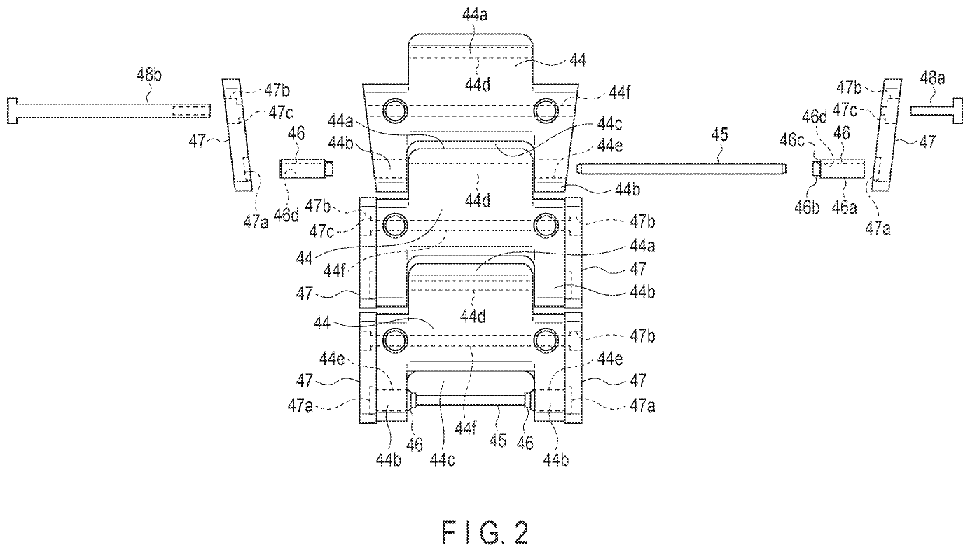

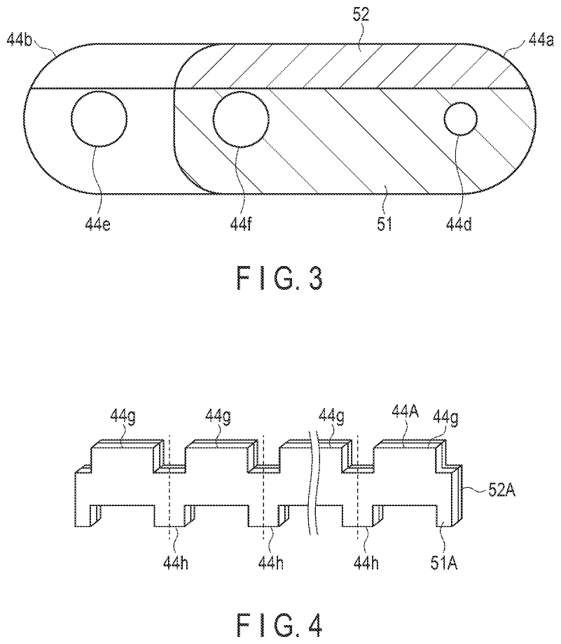

Hereinafter, referring to FIG. 1, FIG. 2, FIG. 3 and FIG. 4, a description is given of a wrist watch 1, a watch band 40, and a band link 44 according to a first embodiment of the present invention. FIG. 1 is a plan view illustrating a configuration of the wrist watch 1, and FIG. 2 is an explanatory view illustrating a configuration of a part of the watch band 40. FIG. 3 is a cross-sectional view of the band link 44. FIG. 4 is an explanatory view of a manufacturing method of the band link 44, and is a plan view illustrating a clad member manufactured in a pre-step. In each Figure, structures are schematically illustrated by being enlarged, reduced or omitted as appropriate. In the preset embodiment, for example, the wrist watch 1 is described by assuming that one side in one direction, toward which an outer surface of a cover 30 faces, is a front side, and the other side in the one direction, toward which an outer surface of a back cover portion constituting a bottom portion of a watch case 10 faces, is a back side. For example, the wrist watch 1 is worn in such an attitude that the outer surface of the back cover portion is opposed to a person's arm that is a wearing object.

Conventionally, as regards a watch band provided on a wrist watch, there is known a configuration in which a plurality of metallic band links are coupled. For example, the watch band includes band links that are arranged in a coupling direction along the circumference of the arm at a time of wearing, and are coupled to each other. Each band link includes, at one end portion, a projection portion including a pin hole, and includes, at the other end portion, a recess portion including a pin hole. For example, it is conventionally disclosed that the projection portion of one band link is disposed in the recess portion of another band link that neighbors the one band link in the coupling direction, and the projection portion and the recess portion are arranged in the width direction, and, by passing a metallic coupling pin through the projection portion and the recess portion, the band links are rotatably coupled.

However, the band link of such a watch band is composed of one layer, there is a problem that the band link is not preferable in design.

The present invention aims at improving the above-described circumstances, and, hereinafter, a description is given of a band link with a good design, a watch band, a watch, and a manufacturing method of the band link.

As illustrated in FIG. 1, the wrist watch 1 includes a watch case 10 constituting an outer shell, a module 20 provided within the watch case 10, a cover 30 covering the front side of the module 20, and a watch band 40 including a pair of band members that are coupled, respectively, to two mutually opposed positions of an outer peripheral portion of the watch case 10.

The watch case 10 is formed circular, and includes a case body 11 provided on an outer peripheral portion of the module 20, a back cover portion disposed on the back side of the module 20, and an exterior case 13 disposed on the outer periphery of the case body 11.

The watch case 10 constitutes, by the case body 11 and the back cover portion, an accommodation portion in which the module 20 is disposed. A front-side opening of the case body 11 is covered by the cover 30.

The case body 11 includes band attachment portions 16 to which band members 41 and 42 are attached, at two mutually opposed positions in the outer peripheral portion of the case body 11, for example, at positions of 6 o'clock, and 12 o'clock. For example, the band attachment portion 16 includes a connection structure including a connection hole (hole portion) that is connected to the band member 41, 42 by a coupling member such as a screw, a pin, a spring bar, or the like. Note that the band attachment portion 16 may be formed as one piece with the watch case 10, or may be formed as a separate body from the watch case 10 and may be assembled to the watch case 10.

The exterior case 13 is provided on the outer periphery of the case body 11. The exterior case 13 is fixed to the case body 11 by a connecting member such as a screw.

The module 20 includes a display portion that displays information such as a time and a date; movements for operating the display portion; a circuit board on which electronic components such as an IC and an antenna are mounted; and various necessary components for watch functions, such as a battery. For example, the display portion may be a digital-type display portion including a liquid crystal display panel with a digital display function, or the like, or may be an analog-type display portion including a dial plate, hands, and the like. Besides, a plurality of display portions may be provided.

The cover 30 is a transparent member formed of, for example, inorganic glass such as SiO₂ glass. For example, the cover 30 is a transparent, disc-shaped watch glass, which is disposed on the front side of the module 20 and covers the module 20. For example, the cover 30 is supported on an inner peripheral edge of a front-side opening of the case body 11. A packing is interposed between the outer periphery of the cover 30 and the inner peripheral edge of the case body 11.

The watch band 40 includes a first band member 41 and a second band member 42, which are connected, respectively, to two opposed positions of the outer periphery of the watch case 10, and a coupling mechanism portion 43 such as a buckle. For example, one end side of each band member 41, 42 is coupled to the watch case 10, and the other end sides thereof are connected to each other by the coupling mechanism portion 43.

Each band member 41, 42 includes a plurality of band links 44 that are arranged in the coupling direction and are rotatably coupled; a coupling pin 45; a buffer member 46; a link cover 47; and a fastening portion 48. In each band member 41, 42, the band links 44 are rotatably coupled by the coupling pins 45, and are arranged in the coupling direction.

The coupling mechanism portion 43 connects the pair of band members 41 and 42. For example, the coupling mechanism portion 43 is a buckle member that is changeable between a fastened state and a released state by changing a connection length by folding or unfolding a plurality of members by a manual operation. If the plural members are unfolded, the connection length between the band members 41 and 42 increases and the coupling mechanism portion 43 enters a released state in which the arm can be inserted or drawn out. If the plural members are folded and locked and the connection length between the band members 41 and 42 decreases, the coupling mechanism portion 43 enters a locked state in which the removal from the arm that is the wearing object can be prevented.

Note that the coupling mechanism portion 43 may be configured to include a plurality of members that are coupled to the band member 41 side and the band member 42 side, respectively, and are separable, and may be configured to separably connect the band member 41 and the band member 42.

Each of the band links 44 has predetermined lengths in the width direction and in the coupling direction. For example, the band link 44 has outer surfaces at both ends in the coupling direction, which are formed in a curved shape curving in an arcuate shape. For example, the band links 44 may have identical structures, or may have partly different shapes. For example, the band link 44, which is provided at an end portion of each band member 41, 42, is coupled to the coupling mechanism portion 43 or band attachment portion 16, which neighbors in the coupling direction, and band links 44 other than the band links 44 at the end portions of the band member 41, 42 are coupled to other neighboring band links 44.

Each of the band links 44 has such a coupling structure as to be coupled to a neighboring band link 44, coupling mechanism portion 43 or band attachment portion 16. For example, each of the band links 44 includes a first projection portion 44a projecting toward one end side, at a center in the width direction of one end portion in the coupling direction, and includes second projection portions 44b projecting toward the other end side, at both ends in the width direction of the other end portion in the coupling direction. The first projection portion 44a and the second projection portions 44b are disposed at different positions in the width direction.

For example, as regards band links 44 neighboring each other in the coupling direction, in a recess portion 44c of one band link 44 formed between the second projection portions 44b at both ends on the other end side, the first projection portion 44a of the other neighboring band link 44 formed at the center on the one end side is disposed.

The first projection portion 44a and second projection portions 44b formed on one end side and the other end side include a first pin hole 44d and a second pin hole 44e, respectively. The pin holes 44d and 44e are through-holes penetrating the first projection portion 44a and second projection portions 44b, respectively, in the width direction perpendicular to, or crossing, the coupling direction. For example, the inside diameter of the first pin hole 44d of the first projection portion 44a at the center is set to be less than the inside diameter of the second pin hole 44e of the second projection portions 44b at both ends.

In addition, a fastening hole 44f serving as a hole portion, in which the fastening portion 48 is disposed, is formed in a portion of the band link 44 between the first projection portion 44a and second projection portions 44b. The fastening hole 44f is a through-hole penetrating the band link 44 in the width direction.

For example, in regard to band links 44 that are continuous in the coupling direction, the first projection portion 44a of one band link 44 is arranged in juxtaposition in the width direction with the second projection portions 44b of another band link 44 that is continuous with the one band link 44 in the coupling direction. In other words, in the recess portion 44c that is a recessed portion between the paired second projection portions 44b formed on both sides in the width direction in one of a pair of mutually neighboring band links 44, the first projection portion 44a of the other band link 44 is disposed, and thereby the second projection portions 44b of the one band link 44 and the first projection portion 44a of the other band link 44 are arranged in juxtaposition in the width direction.

The first pin hole 44d of the first projection portion 44a of one of paired band links 44 and the second pin holes 44e of the paired second projection portion 44b of the other band link 44 are continuous in the width direction. The coupling pin 45 is disposed through the continuous pin holes 44d and 44e, and thereby the band links 44 are rotatably coupled.

Note that among the band links 44 provided in each band member 41, 42, for example, in the band link 44 disposed at an end portion in the coupling direction, the first projection portion 44a or the second projection portions 44b are coupled to the band attachment portion 16 or the coupling mechanism portion 43 by the coupling member disposed in the pin holes 44d and 44e.

The band link 44 has a multilayer structure including, in a stacked manner, a plurality of layers 51 and 52 that are formed of different materials. For example, the band link 44 has a two-layer structure including a base layer 51 formed of a first metallic material, and a cover layer 52 formed of a second metallic material.

The base layer 51 forms an inner-side surface that comes in contact with the skin at a time of wearing. The base layer 51 includes the first metallic material. The first metallic material is, for example, Ti. Preferably, the base layer 51 is formed of pure titanium. For example, the density of Ti is 4.43 g/cm³, and the base layer 51 is formed of a material having a lower density, i.e., a lower specific gravity, than the cover layer 52. The pin holes 44d and 44e and the fastening hole 44f are formed in the base layer 51. In addition, in the band link 44 disposed at the end portion, various holes connected to the band attachment portion 16 or coupling mechanism portion 43 are also formed in the base layer 51. In other words, in the band link 44, a region where the pin holes 44d and 44e, fastening hole 44f and hole portions for connection are provided is formed in the base layer 51. For example, a thickness dimension of the base layer 51 in the direction of stacking is greater than ½ of a thickness dimension of the band link 44. Specifically, a boundary between the base layer 51 and the cover layer 52 is located more on the front side than the center in the thickness direction of the band link 44. For example, a boundary between the base layer 51 and cover layer 52, i.e., a surface of the base layer 51, which is opposed to the cover layer 52, forms a smooth surface.

The cover layer 52 is stacked on the front side of the base layer 51. The cover layer 52 includes the second metallic material, and constitutes a front side at a time of wearing, i.e., an outer-side surface that is disposed on the side opposite to the arm. The cover layer 52 is formed to have a higher hardness than the base layer 51. For example, the second metallic material, of which the cover layer 52 is formed, has a higher Vickers hardness than the first metallic material, of which the base layer 51 is formed. In addition, the second metallic material has a higher density and a greater specific gravity than the first metallic material. The second metallic material is, for example, COBARION (trademark) in which chromium and molybdenum are mixed in cobalt, the density of which is 8.4 g/cm³. For example, the cover layer 52 has a thickness dimension that is smaller than ½ of the thickness of the band link 44, and is at, for example, 1/10 or more, and ½ or less.

The buffer member 46 is formed in a tubular shape of a soft synthetic resin material having elasticity, such as silicone rubber. The buffer member 46 is provided at each of both end portions in the width direction of each of the band links 44. Specifically, the buffer member 46 is provided in an inserted manner on an outer periphery of each of both end portions of one coupling pin 45. The buffer member 46 is formed in a cylindrical shape including a cylindrical hole 46d extending in the axial direction. The buffer member 46 includes a large-diameter portion 46a that is provided one one side in the axial direction, and a small-diameter portion 46b that is provided on the other side in the axial direction, and a stepped portion 46c is formed between the large-diameter portion 46a and the small-diameter portion 46b. The buffer members 46 are disposed such that the axial direction thereof extends in the width direction of the band link 44. The large-diameter portions 46a of the buffer members 46 are disposed in the pin holes 44e of the second projection portions 44b on both sides, the small-diameter portions 46b of the buffer members 46 are disposed at end portions of the pin hole 44d of the first projection portion 44a at the center, and the stepped portions 46c of the buffer members 46 are hooked at peripheral edges of the pin hole 44d of the first projection portion 44a. Specifically, the buffer members 46 are inserted between the first projection portion 44a and the second projection portions 44b of the paired band links 44, which neighbor in the width direction, and restrict the positions of the first projection portion 44a and the second projection portions 44b.

The link cover 47 is provided on each of both ends in the width direction of the band links 44 that are coupled by the insertion of the coupling pin 45. The link cover 47 includes a counterbore portion 47a that is a recess in which the coupling pin 45 and buffer member 46 projecting from the band link 44 in the width direction are disposed, and covers an end portion of the band link 44 and end portions of the coupling pin 45 and buffer member 46. In addition, the link cover 47 includes, in outer faces at both ends in the width direction, a step 47c for hooking a head portion of the fastening portion 48, and a cover fastening hole 47b through which a shaft portion of the fastening portion 48 is passed, and the link covers 47 at both ends clamp and fasten the band link 44 by the fastening portion 48.

The fastening portion 48 includes a male screw portion 48a that is disposed on one side in the width direction, and a female screw portion 48b that is disposed on the other side in the width direction. For example, each of the male screw portion 48a and female screw portion 48b includes a shaft portion, which extends in the axial direction and on which a screw is formed, and a head portion provided at an end portion of the shaft portion. The shaft portion of the male screw portion 48a is engaged with the shaft portion of the female screw portion 48b. The head portions of the male screw portion 48a and female screw portion 48b are hooked on the steps 47c formed in the cover fastening holes 47b of the link covers 47, and the shaft portions are engaged, and thereby the fastening portion 48 fastens the pair of link covers 47 that are provided in such a manner as to sandwich the band link 44.

Hereinafter, a manufacturing method of the band link 44 in the present embodiment is described. The manufacturing method of the band link 44 includes a primary step of forming, as a primary processed part illustrated in FIG. 4, a rod-shaped clad member 44A before being divided into a plurality of band links 44, and a secondary step of dividing the clad member 44A into a plurality of pieces and forming a plurality of band links 44 by surface treatment, boring and the like. The primary step includes a core formation step and an HIP step. For example, the clad member 44A is formed to be elongated in one direction, and is shaped such that a plurality of projections 44g, which become the first projection portions 44a, are formed on one edge at a predetermined pitch, and a plurality of projections 44h, which become the second projection portions 44b, are formed on the other edge at a predetermined pitch.

In the core formation step, for example, by a 3D printer, a base portion 51A, which becomes the base layer 51, is formed of the first metallic material. The base portion 51A has an elongated plate shape with predetermined thickness and width.

Subsequently, in the HIP step, by HIP (Hot Isostatic Pressing), a processing material is pressure-processed at high temperatures and high pressure (gas pressure), and thereby a cover portion 52A, which becomes the cover layer 52, is formed of the powder of the second metallic material.

For example, a mold for the HIP process, which corresponds to the shape of the clad member 44A to be formed, is prepared. The base portion 51A is disposed as a core member in the mold, and the powder of the second metallic material is filled. Then, the mold is disposed in a chamber for the HIP process, the cover portion 52A is formed by performing heat-pressing at high pressure and high temperatures, and the base portion 51A and cover portion 52A are sintered and formed as one piece. After the sintering, by removing the mold, the clad member 44A of the two-layer structure is formed. For example, the conditions for the HIP process are set to be 2000 atmospheres and 900° C. to 1000° C.

Then, in the secondary step, the clad member 44A is cut and divided into a plurality of link members, and subjected to a cutting process, surface treatment and the like for forming the pin holes 44d and 44e and fastening holes 44f, and thus a plurality band links 44 are completely manufactured. At this time, the pin holes 44d and 44e and fastening holes 44f are formed in the base layer 51 in the width direction. Specifically, the pin holes 44d and 44e are disposed such that the pin holes 44d and 44e do not pass through the cover layer 52.

According to the band link 44, watch band 40 and watch 1 having the above-described structures, the designability can be improved. In addition, wear resistance and flaw tolerance, and workability, can compatibly be achieved. In other words, the cover layer 52, which forms a front-side surface at a time of wearing, is formed of a hard material with high specularity, and the back-side base layer 51 is formed of a soft, light material with good workability, and therefore, while the flaw tolerance, wear resistance and specularity are secured by the cover layer 52, light band links with high safety and workability can be constituted by the base layer 51. Moreover, since the pin holes 44d and 44e and fastening holes 44f can easily be processed, the degree of freedom in shape is high.

Additionally, according to the above embodiment, by sintering the powder of the metallic material by the HIP process, the formation of the cover layer 52 and the coupling of the base layer 51 and cover layer 52 can be performed. For example, even with respect to COBARION that is difficult to process, a desired shape can easily obtained by the formation by the HIP process with use of powder.

Note that the above-described embodiment is merely an example, and does not restrict the scope of the invention.

For example, band links of the above-described two-layer structure may be used for only some of a plurality of band links.

Additionally, a plurality of band links constituting the band may have different structures. For example, the ratio between the base layer 51 and the cover layer 52 may be made different in accordance with positions of band links, and the weight of the band links can be adjusted by making greater the ratio of COBARION with a high density at a position closer to the band attachment portion 16 that is remote from the watch case body. For example, in the case of such a disposition that the band links 44 on the coupling mechanism portion 43 side become heavier, it is possible to obtain an advantageous effect that the direction of the dial plate becomes stable at a time of placing the watch 1 or wearing the watch 1 on the arm.

Additionally, the boundary portion, i.e., the surface of the base layer 51, which is opposed to the cover layer 52, is not limited to the smooth surface. For example, the boundary portion may be configured to include an irregular portion or a corrugated portion. For example, with the boundary portion including an irregular portion or a corrugated portion, the strength of coupling to the cover layer 52 can be improved.

Additionally, in the above-described embodiment, the configuration including the link covers 47 is exemplarily illustrated, but the configuration is not limited to this, and a configuration without the link covers 47 may be adopted. In this case, the fastening portion 48 or fastening hole 44f can be omitted.

Additionally, in the above-described embodiment, the example is illustrated in which the base layer 51 is formed by the 3D printer, and the cover layer 52 is formed by the HIP process, but the embodiment is not limited to this. For example, in the core formation step, the cover portion 52A may be formed by the 3D printer from the second metallic material, and in the HIP process, the base layer 51 may be formed from the powder of the first metallic material. In this case, the cover portion 52A is disposed as a core member, together with the powder of the first metallic material, in the mold of the HIP process, and the HIP process is performed, and thereby the powder formed of the first metallic material is sintered to form the base portion 51A, and, at the same time, the cover portion 52a as the core member of the second metallic material, and the base portion 51A, are coupled.

Additionally, the materials used as the first metallic material and second metallic material are not limited to the examples of the above-described embodiment. For example, titanium may be used as the first metallic material that forms the base layer 51, and 64 titanium may be used as the second metallic material that forms the cover layer 52. Alternatively, SUS may be used as the first metallic material that forms the base layer 51, and 64 titanium may be used as the second metallic material that forms the cover layer 52.

Additionally, not only the band link 44, but also other watch components, such as the watch case 10 and coupling mechanism portion 43, may be composed of a multilayer structure including the base layer 51 formed of the first metallic material and the cover layer 52 formed of the second metallic material.

What is claimed is:

1. A band link comprising:
a base layer formed of a first metallic material and the base layer being with a hole portion in which a coupling member is disposed; and
a cover layer formed of a second metallic material that is different from the first metallic material, the cover layer being stacked on one side of the base layer,
the base layer and the cover layer being formed as one piece.

2. The band link of claim 1, wherein the second metallic material has a higher hardness than the first metallic material.

3. The band link of claim 1, wherein the first metallic material is Ti, and the second metallic material is COBARION.

4. A watch band comprising:
a plurality of the band links of claim 1; and
a plurality of coupling members configured to couple the band links such that the band links are rotatable in a coupling direction crossing a stacking direction in which the base layer and the cover layer are stacked.

5. The watch band of claim 4, wherein the base layer forms an inner-side surface that is opposed to a wearing object at a time of wearing.

6. The watch band of claim 4, wherein the cover layer forms an outer-side surface facing toward an outside at a time of wearing.

7. The watch band of claim 6, wherein each of the band links includes, at an end portion on one side in the coupling direction, a first projection portion which projects toward the one side in the coupling direction and in which the hole portion is formed, and includes, at an end portion on the other side in the coupling direction, a second projection portion which projects toward the other side in the coupling direction and in which the hole portion is formed.

8. The watch band of claim 7, wherein the hole portion is formed along a width direction crossing the coupling direction and the stacking direction.

9. The watch band of claim 8, wherein the second projection portion of one of a pair of the band links that neighbor each other is arranged in juxtaposition in the width direction with the first projection portion of the other neighboring band link, and the hole portions formed in the base layers of the pair of the band links are arranged in juxtaposition in the width direction.

10. The watch band of claim 9, wherein the band links are rotatably coupled by the coupling member being disposed in the first projection portion and the second projection portion that are juxtaposed in the width direction.

11. A watch comprising:
the watch band of claim 6;
a watch case to which the watch band is attached; and
a module disposed in an accommodation portion in the watch case.

12. A watch comprising:
the watch band of claim 10;
a watch case to which the watch band is attached; and
a module disposed in an accommodation portion in the watch case.

13. A manufacturing method of a band link, comprising:
a core formation step of forming a core member of a metallic material that is one of a first metallic material and a second metallic material with a higher hardness than the first metallic material; and
an HIP step of heating and pressing, by an HIP process, powder of the other of the first metallic material and the second metallic material, and the core member.

14. The manufacturing method of a band link of claim 13, further comprising a primary step of fabricating a clad member in which a base layer formed of the first metallic material and a cover layer formed of the second metallic material are stacked.

15. The manufacturing method of a band link of claim 14, wherein in the core formation step, the first metallic material or the second metallic material is formed by a 3D printer.

16. The manufacturing method of a band link of claim 14, further comprising a secondary step of, after the primary step, cutting and separating the clad member into a plurality of link members, and forming a hole portion by processing the base layer of the link member.

17. The manufacturing method of a band link of claim 15, further comprising a secondary step of, after the primary step, cutting and separating the clad member into a plurality of link members, and forming a hole portion by processing the base layer of the link member.

18. The manufacturing method of a band link of claim 14, wherein the first metallic material is Ti, and the second metallic material is COBARION.

19. The manufacturing method of a band link of claim 15, wherein the first metallic material is Ti, and the second metallic material is COBARION.

20. The manufacturing method of a band link of claim 16, wherein the first metallic material is Ti, and the second metallic material is COBARION.
